(19) United States
(12) Patent Application Publication
(10) Pub. No.: US 2014/0167303 A1
(43) Pub. Date: Jun. 19, 2014

(54) PRESSING TOOL AND METHOD FOR PRODUCING A SILICONE ELEMENT

(71) Applicants: Markus Boss, Regensburg (DE); Martin Brandl, Kelheim (DE); Markus Pindl, Tegernheim (DE)

(72) Inventors: Markus Boss, Regensburg (DE); Martin Brandl, Kelheim (DE); Markus Pindl, Tegernheim (DE)

(73) Assignee: OSRAM Opto Semiconductors GmbH, Regensburg (DE)

(21) Appl. No.: 14/238,218

(22) PCT Filed: Aug. 31, 2012
(86) PCT No.: PCT/EP2012/066952

§ 371 Date: Feb. 11, 2014

(30) Foreign Application Priority Data
Sep. 6, 2011 (DE) 102011082157.0

(51) Int. Cl. B29C 43/58; B29C 43/20

(52) U.S. Cl. CPC B29C 43/58; B29C 43/203
USPC 264/40.5; 425/520; 264/259

(57) ABSTRACT

A pressing tool for pressing a silicone element may include: an upper pressing tool half and a lower pressing tool half, which in the closed state of the pressing tool form a cavity for pressing a silicone element, and a carrier foil, which bears on one of the pressing tool halves, for the silicone element to be pressed, wherein at least the upper pressing tool half or the lower pressing tool half has at least one clamping element for aligning the two pressing tool halves with respect to one another, and wherein the clamping element is arranged between the pressing tool halves and outside the region covered by the carrier foil.

### RELATED APPLICATIONS

The present application is a national stage entry according to 35 U.S.C. §371 of PCT application No.: PCT/EP2012/066952 filed on Aug. 31, 2012, which claims priority from German application No.: 10 2011 082 157.0 filed on Sep. 6, 2011, and is incorporated herein by reference in its entirety.

### TECHNICAL FIELD

Various embodiments relate to a pressing tool for producing a silicone element and to a method for producing a silicone element.

In particular, various embodiments relate to a pressing tool for pressing a silicone element which, for example, is used in the form of individualized silicone laminae as a radiation conversion element in an optoelectronic semiconductor component.

### BACKGROUND

One example of an optoelectronic semiconductor component has an electrically contacted semiconductor chip with a radiation conversion element, in which case the semiconductor chip and the radiation conversion element may be embedded in a potting compound. During operation, the semiconductor chip emits primary radiation and a part of the primary radiation is converted into secondary radiation of a different wavelength in the radiation conversion element. The resulting radiation of the optoelectronic semiconductor component is given by the superposition of the primary radiation transmitted by the radiation conversion element and the secondary radiation generated. In this way, in particular, it is possible to provide light sources which emit white light.

The radiation conversion element made from the silicone element is in this case produced separately from the semiconductor chip subsequently applied onto the semiconductor chip by means of a suitable method, and optionally embedded in a package.

In a manner which is known, the silicone element from which the radiation conversion element is obtained by corresponding individualization processes is produced by a pressing method. In this case, a silicone base compound is introduced into the cavity of a pressing tool and brought into the shape of the silicone element by pressing. Here, it is important for the silicone element to have as constant a thickness as possible along its entire extent.

### SUMMARY

Various embodiments provide a pressing tool for producing a silicone element as well as a method for producing a silicone element, which improves the production of a silicone element by means of pressing.

The present disclosure relates to a pressing tool for pressing a silicone element, having an upper pressing tool half and a lower pressing tool half, which in the closed state of the pressing tool form a cavity for pressing a silicone element, and a carrier foil, which bears on one of the pressing tool halves, for the silicone element to be pressed, wherein at least the upper pressing tool half or the lower pressing tool half has at least one clamping element for aligning the two pressing tool halves with respect to one another, and wherein the clamping element is arranged between the pressing tool halves and outside the region covered by the carrier foil.

By providing at least one clamping element at a position which is not covered by the soft and pliable carrier foil, very precise alignment of the pressing tool halves with respect to one another can be made possible. Tool tolerances such as tilting and unevenness can thereby be compensated for, so that the pressing tool halves can be aligned exactly with respect to one another in such a way that the pressed silicone element has an essentially constant thickness.

According to one embodiment, the at least one clamping element in the closed state of the pressing tool is in at least indirect contact with the two pressing tool halves and is provided for clamping force transmission between the pressing tool halves.

According to one embodiment, the clamping element is rigidly connected to the pressing tool half which has the clamping element. The clamping element is therefore connected to the corresponding pressing tool half not, for example, by means of a spring or other flexible components. In this way, it is possible to achieve precise alignment and optimal clamping force transmission without tilting of the two pressing tool halves with respect to one another.

The fact that the clamping force transmission takes place directly, or at least without the carrier foil between the pressing tool halves, permits clamping force transmission via hard and nonpliable materials. The carrier foil therefore no longer plays any part in the clamping force transmission, so that a high accuracy of the alignment of the pressing tool halves with respect to one another and a high reproducibility of this alignment are achieved.

According to one embodiment, the clamping element extends around the cavity. In this way, uniform force transmission is ensured throughout the region of the cavity.

Preferably, the clamping element has a constant circumferential distance from the edge of the cavity. The further outward the clamping element is applied, the better the variations in the thickness of the silicone element can be controlled, since the clamping element then has a kind of lever action on the alignment of the pressing tool halves with respect to one another in the region of the cavity.

In one embodiment, the clamping element is in the form of a frame. In an alternative embodiment, the clamping element is in the form of a circular ring. In this way, the clamping element can replicate the shape of the edge of the cavity so that uniform force transmission is in turn ensured throughout the region of the cavity.

The clamping element preferably has a constant width. In this way, the same possibility of force transmission is available at all positions of the clamping element, so that the force transmission can take place uniformly.

In one embodiment, the clamping element consists of a plurality of clamping blocks. The use of clamping blocks offers the possibility of saving material when producing the clamping element.

According to one embodiment, the clamping element varies in its height. In this way, depending on the pressing tool, tolerances in the pressing tool can be compensated for in a controlled way and the clamping element can be adapted to the respective tool structures.

Preferably, the clamping element has at least one compensating element applied for the height variation. By virtue of the application of compensating elements, the clamping element remains variable. This offers the possibility of still compensating for tool tolerances subsequently at any time. If the compensating element is formed so that it can be removed, the clamping element can be adapted in any desired way to new tool structures at any time.

In one embodiment, the clamping element is made of steel. In this way, a rigid and nonpliable alignment of the pressing tool halves with respect to one another can be achieved. In particular, good force transmission can be ensured in this way.

In one embodiment, the carrier foil is made of polytetrafluoroethylene, PTFE. A foil of this type offers optimal properties for the adhesion and further processing of the pressed silicone element.

Various embodiments furthermore relate to a method for producing a silicone element by means of a pressing tool as described, having the steps of providing at least one clamping element for aligning the pressing tool halves with respect to one another, and pressing a silicone element by means of the pressing tool.

By providing at least one clamping element at a position which is not covered by the soft and pliable carrier foil, very precise alignment of the pressing tool halves with respect to one another can be made possible. Tool tolerances such as tilting and unevenness can thereby be compensated for, so that the pressing tool halves can be aligned exactly with respect to one another in such a way that the pressed silicone element has an essentially constant thickness. The production of the silicone element is thereby improved.

In one embodiment, the method furthermore has the steps of: measuring the thickness variation of the pressed silicone element, and varying a height of the clamping element as a function of the measured thickness variation.

In this way, the clamping element can be adapted to the tool structure once or several times iteratively, so that the same accuracy in the thickness of the pressed silicone element is achieved in each pressing tool.

Preferably, the step of varying the height of the clamping element includes placement of at least one compensating element onto the clamping element. By virtue of the application of compensating elements, the clamping element remains variable. This offers the possibility of still compensating for tool tolerances subsequently at any time. If the compensating element is formed so that it can be removed, the clamping element can be adapted in any desired way to new tool structures at any time.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a schematic representation of a cross section of an open pressing tool according to the disclosure,

FIG. 2 shows a schematic representation of a cross section of the pressing tool according to the disclosure of FIG. 1 in the closed state,

FIG. 3 shows a schematic representation of a carrier foil with a silicone element applied,

FIG. 4 shows a plan view of a pressing tool half having a clamping element, according to a first embodiment,

FIG. 5 shows a plan view of a pressing tool half having a clamping element, according to a second embodiment,

FIG. 6 shows a plan view of a pressing tool half having a clamping element, according to a third embodiment,

FIG. 7 shows a schematic representation of a cross section along the line L-L′ in FIG. 4 and FIG. 5, and

FIG. 8 shows a flowchart of the method steps for producing the silicone element according to the present disclosure.

### DETAILED DESCRIPTION

The following detailed description refers to the accompanying drawing that show, by way of illustration, specific details and embodiments in which the disclosure may be practiced.

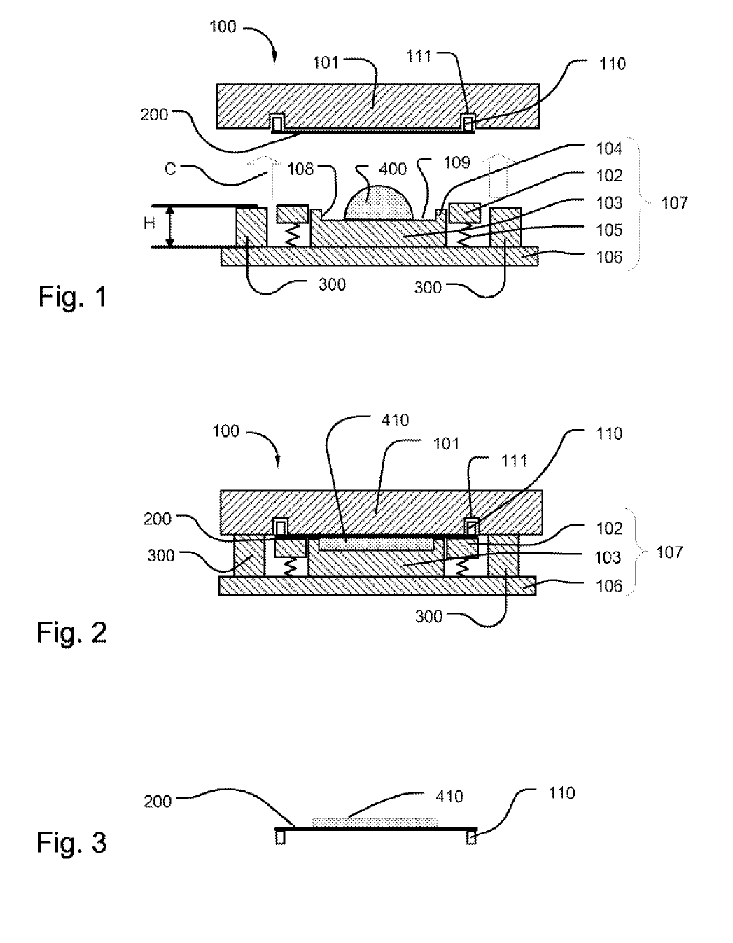

FIG. 1 shows a schematic representation of a cross section of a pressing tool 100 according to the disclosure in the open state. The pressing tool 100 consists of a plurality of pressing tool parts 101, 102, 103, 106, which form an upper pressing tool half 101 (top mold) and a lower pressing tool half 107 (bottom mold). In the closed state of the pressing tool 100, a cavity 109 is formed between the upper pressing tool half 101 and the lower pressing tool half 107. In this case, the cavity 109 is formed by the upper pressing tool half 101 and an inner lower pressing tool part 103. In the inner lower pressing tool part 103, the cavity 109 is formed by means of an indentation which is bounded at the edge by a circumferential rim 104. In plan view, perpendicularly to the plane of the drawing of FIG. 1, the cavity 109 is for example configured circularly. An outer lower pressing tool part 102 is supported resiliently by means of springing 105 in this example. The inner lower pressing tool part 103 and the outer lower pressing tool part 102 are applied on a base plate 106 or clamping plate in this pressing tool 100. The inner lower pressing tool part 103 is preferably connected firmly, for example screwed, to the base plate 106. The inner lower pressing tool part 103 may also be formed integrally with the base plate 106.

The pressing tool 100 represented is in this case only exemplary, and the present disclosure may be used in any type of pressing tool 100 having a different number and type of pressing tool parts. In particular, the cavity 109 may also be bounded by more than two pressing tool parts. Particularly, the circumferential rim 104 may also be omitted, so that the cavity 109 is bounded laterally by the outer lower pressing tool part 102. The pressing method is preferably a compression molding method, although the disclosure may also be used for a transfer molding method.

A mold release foil (not represented in the figures), which extends laterally beyond the cavity 109, is applied onto the lower pressing tool half 107. The mold release foil may adopt the shape of a part of the cavity 109 and/or of a lower pressing tool part 102, 103 defining the cavity 109. During the pressing, the mold release foil may in particular also replicate a shape of the cavity 109 that varies as a result of the pressing process.

A carrier foil 200 is applied onto the upper pressing tool half 101. This is a foil which is different to the mold release foil and is preferably not, or not significantly, deformed during the pressing. The carrier foil 200 is, in particular, adapted to carry the silicone element produced by the pressing method after the pressing. For example, the carrier foil 200 is formed in a flat and planar fashion. The carrier foil 200 preferably bears at least indirectly on a flat surface of the upper pressing tool half 101. In particular, the carrier foil 200 does not adapt to the cavity 109. The carrier foil 200 is in this case applied onto a clamping ring 110, which is fitted into a corresponding groove 11 in the upper pressing tool half 101 for the pressing process. For each pressing process, the clamping ring 110 is then fitted with the carrier foil 200 manually or in an automated fashion into the pressing tool 100, removed after the pressing process and replaced by a new clamping ring 110 with a carrier foil 200.

Subsequently, a silicone base compound 400 is applied onto the mold release foil and/or the carrier foil 200.

Preferably, the silicone base compound 400 is applied inside the cavity 109. The silicone base compound 400 is for example at least one polysilane, siloxane and/or polysiloxane. The silicone base compound 400 constitutes a starting material for the silicone element to be produced. The silicone base compound 400 is not fully cured and/or not fully crosslinked during application. Furthermore, the silicone base compound 400 has a relatively high viscosity and does not flow, or does not flow significantly, during introduction into the pressing tool 100. That is to say, the silicone base compound 400 does not flow by itself on the mold release foil 110 or the carrier foil 200. In particular, the viscosity of the silicone base compound during the application may be at least 10 Pa•s or at least 20 Pa•s.

A conversion medium (not shown in the figures), for example in the form of conversion medium particles, may be added, preferably homogeneously distributed, to the silicone base compound 400. The conversion medium is suitable for at least partially absorbing electromagnetic radiation in a first wavelength range and converting it into radiation in a second wavelength range, which is different to the first wavelength range. For example, the conversion medium may be adapted to absorb radiation in a wavelength range of between 420 nm and 490 nm inclusive, and convert it into longer-wavelength radiation.

The conversion medium particles include for example a rare earth-doped garnet such as YAG:Ce, a rare earth-doped orthosilicate such as (Ba,Sr)₂SiO₄:EU or a rare earth-doped silicon oxynitride or silicon nitride such as (Ba,Sr)₂Si₅N₈:Eu. An average diameter of the conversion medium particles lies for example between 2 μm and 20 μm inclusive, in particular between 3 μm and 15 μm inclusive. A proportion of the conversion medium particles by weight to the overall silicone element formed from the silicone base compound 400 lies, in particular, between 5 percent by weight and 80 percent by weight inclusive, preferably between 10 percent by weight and 25 percent by weight inclusive, or between 60 percent by weight and 80 percent by weight inclusive.

Optionally, other preferred particulate materials, for example to increase the thermal conductivity of the silicone element or as diffuser particles, may be added to the silicone base compound 400, preferably in a proportion by weight of between 0 percent by weight and 50 percent by weight inclusive. Such particles contain or consist, in particular, of oxides or metal fluorides such as aluminum oxide, silicon oxide or calcium fluoride. Average diameters of the particles preferably lie between 2 μm and 20 μm inclusive.

The pressing tool 100 is subsequently closed by moving the lower pressing tool half 107 toward the upper pressing tool half 101, for example as shown by the arrow C in FIG. 1. The movement may, naturally, also be carried out in a different direction or on both sides.

FIG. 2 shows the pressing tool 100 in the closed state. When the pressing tool 100 is being closed, the upper pressing tool half 101 presses onto the rim 104 of the inner lower pressing tool part 103, so that the cavity 109 is closed. In an alternative configuration of the pressing tool 100, in which the inner lower pressing tool part 103 is formed in a planar fashion and without a rim 104, the edge of the cavity 109 is formed by the outer lower pressing tool part 102. In this case, during closure, the upper pressing tool half 101 presses onto the resiliently supported outer lower pressing tool part 102, which therefore yields so that the cavity 109 is closed. The closure of the pressing tool 100 may be carried out in a vacuum. It is likewise possible for the pressing tool 100 to have air outlets (not shown in the figures).

When the pressing tool 100 is being closed, the mold release foil and the carrier foil 200 are pressed directly on to one another, so that the cavity 109 is sealed. By the pressing process, the silicone base compound 400 is pressed into the shape of the cavity 109 and therefore into the shape of the silicone element 410. The silicone base compound forming the silicone element 410 lies essentially between the carrier foil 200 and the mold release foil, and is in direct contact with them.

In the closed state of the pressing tool 100, the shaped silicone element 410 is, for example, thermally or photochemically precured or fully cured. In the case of photochemical precuring, or curing, ultraviolet radiation may for example be shone through the upper pressing tool half 101 and through the carrier foil 200 into the silicone element 410.

The silicone element 410 pressed into shape may remain precured with the pressing tool 100 still closed and not fully cured until after the pressing tool 100 is opened.

Specific requirements particularly in terms of extensibility, tear resistance, deformability and surface condition are placed on the mold release foil. Owing to this, a selection of materials for the mold release foil is very restricted. In particular, it may be the case that the silicone element to be produced on the mold release foil exhibits a relatively strong adhesion after the pressing, which is undesired since for further processing the silicone element 410 should adhere only on the carrier foil 200. Preferred materials for the mold release foil are therefore for example ethylene tetrafluoroethylene (ETFE), perfluoroethylene propylene (FEP), polyetherimide (PEI) or polytetrafluoroethylene (PTFE). The removal of the mold release foil 210 may take place before or after full curing of the silicone element 410.

FIG. 3 shows the clamping ring 110 with the carrier foil 200 after the pressing process with the silicone element 410 applied. The mold release foil is already removed from the silicone element 410.

Optionally, in a subsequent step, the silicone element 410 produced may also be divided into individual silicone laminae, for example by stamping, cutting, water-jet cutting, lasering. A size of the silicone laminae, as seen in plan view, lies for example between 0.25 mm² and 4 mm² inclusive, in particular between 1 mm² and 2 mm² inclusive. The carrier foil may also be subjected to the individualization. The silicone laminae may then, for example, be used as a converter element in an optoelectronic semiconductor component. The semiconductor component includes at least one optoelectronic semiconductor chip, preferably a light-emitting diode, abbreviated to LED, which emits a maximum intensity particularly in the wavelength range of between 420 nm and 490 nm inclusive.

An average thickness T of the silicone element 410 preferably lies between 10 μm and 1 mm inclusive, or between 50 μm and 150 μm inclusive. A hardness of the fully cured silicone element 410 lies in particular between Shore A30 and Shore A90.

According to the present disclosure, at least one clamping element 300 is provided on at least the upper pressing tool half 101 and/or the lower pressing tool half 107, this clamping element being arranged between the upper pressing tool half 101 and the lower pressing tool half 107 and outside the region covered by the carrier foil 200. In the closed state of the pressing tool 100, the clamping element 300 is therefore in at least indirect contact with the upper pressing tool half 101 and the lower pressing tool half 107, although the clamping element is not in contact with the carrier foil 200.

In other words, the pressing tool half on which the carrier foil 200 bears extends beyond the carrier foil 200 in the lateral direction, and the clamping element 300 is provided in the region of the pressing tool half which extends laterally beyond the carrier foil 200. In this embodiment, the carrier foil 200 bears on the upper pressing tool half 101, although the carrier foil 200 may also be provided on the lower pressing tool half 107 and the indentation and the edge 108 of the cavity 109 may correspondingly be formed by an upper pressing tool half 101 in one or more parts.

The clamping element 300 is used to align the upper pressing tool half 101 with respect to the lower pressing tool half 107. In particular, the clamping element 300 is used to align the pressing tool parts which form the cavity 109 with respect to one another. Since, as already explained, the silicone element 410 to be pressed has a thickness of between 10 μm and 1 mm, even very small tilts of the pressing tool halves 101, 107 with respect to one another can lead to a thickness variation in the silicone element 410 and therefore to a deviation from the target layer thickness.

Thickness variations of the silicone element lead to different problems, depending on the use of the silicone element. If the silicone element is for example used in the form of silicone laminae in an optoelectronic semiconductor component, the optical properties of the optoelectronic semiconductor component may vary with the thickness of the silicone laminae used, so that constant and reproducible optical properties of the optoelectronic semiconductor component are not ensured. In particular when the silicone element is used as a radiation conversion element in an optoelectronic semiconductor component, thickness variations can lead to a spread in the color locus of the radiation conversion element. With respect to the color locus variation which results from a thickness variation within a silicone element, even a thickness difference of 1 μm has a negative effect. All these problems are avoided, or at least significantly reduced, by improved alignment of the pressing tool halves with respect to one another.

In a known pressing tool, when the upper and lower pressing tool halves are brought together, contact of the pressing tool halves and therefore force transmission takes place only in the region of the cavity, for example through the circumferential rim, but this force transmission therefore also takes place in the region of the carrier foil. In other words, the circumferential rim or other components sink into the carrier foil so that exact alignment of the pressing tool halves with respect to one another is not possible. The carrier foil therefore acts as a buffer, that is to say the carrier foil is compressed more strongly on one side than on the other side. The clamping force transmission, and therefore the effect of alignment of the tool halves with respect to one another, are therefore significantly reduced. Tolerances in the pressing tool and the mold apparatus therefore lead to undesired deviations from the target layer thickness of the silicone element. By virtue of the present disclosure, the clamping force transmission takes place by means of the clamping element, and therefore not in the region of the carrier foil 200, so that the effect of the sinking of force transmission elements is reduced or avoided in the present disclosure.

The carrier foil 200 preferably consists of polytetrafluoroethylene (PTFE), since this makes reliable further processing of the silicone element 410 possible after removal from the pressing tool 100. Other foils, for example metal substrates, which are less pliable and therefore do not permit, or permit less, sinking of components into the foil, are not suitable for the special application of a silicone element 410 to be pressed owing to difficult and elaborate further processing. For example, the silicone element 410 would need to be relaminated in a further step from the metal substrate onto UV foil, which is in turn scarcely possible or possible only with the use of release agents.

The present disclosure therefore proposes separate sealing and aligning elements. The circumferential rim 104, or the outer lower pressing tool part 102, constitute a sealing element which laterally seals the cavity 109 directly on the carrier foil 200. Separately therefrom, the clamping element 300 is provided as an aligning element for aligning the pressing tool halves 101, 107 with respect to one another. The clamping element 300 in this case has either direct contact with the two pressing tool halves 101, 107 or at least indirect contact with the two pressing tool halves 101, 107 via one or more foils with negligible thickness and pliability, for example a mold release foil or separating foil, for example made of ethylene tetrafluoroethylene ETFE.

The majority of the force between the base plates or clamping plates of the lower pressing tool half 107 and the upper pressing tool half 101 is thus transmitted through the clamping element 300. The soft carrier foil 200 therefore no longer plays any part in the clamping force transmission. The achievable accuracy of the thickness of the silicone element 410 therefore depends only on the matching of the pressure surfaces of the clamping element 300 to the two pressing tool halves 101, 107. If the overall machine structure has tolerances, for example tilting of the pressing tool halves 101, 107 with respect to one another, these can be compensated for by modifying the clamping element 300. The same precision can therefore be achieved on each apparatus and tool combination.

In particular, the alignment of the pressing tool halves 101, 107 with respect to one another can be controlled by varying the number, arrangement and/or height of the at least one clamping element 300.

The clamping element 300 may be provided on the upper pressing tool half 101 or on the lower pressing tool half 107. In the case of a multi-part clamping element 300, the parts may be provided on one pressing tool half or distributed between the two pressing tool halves 101, 107.

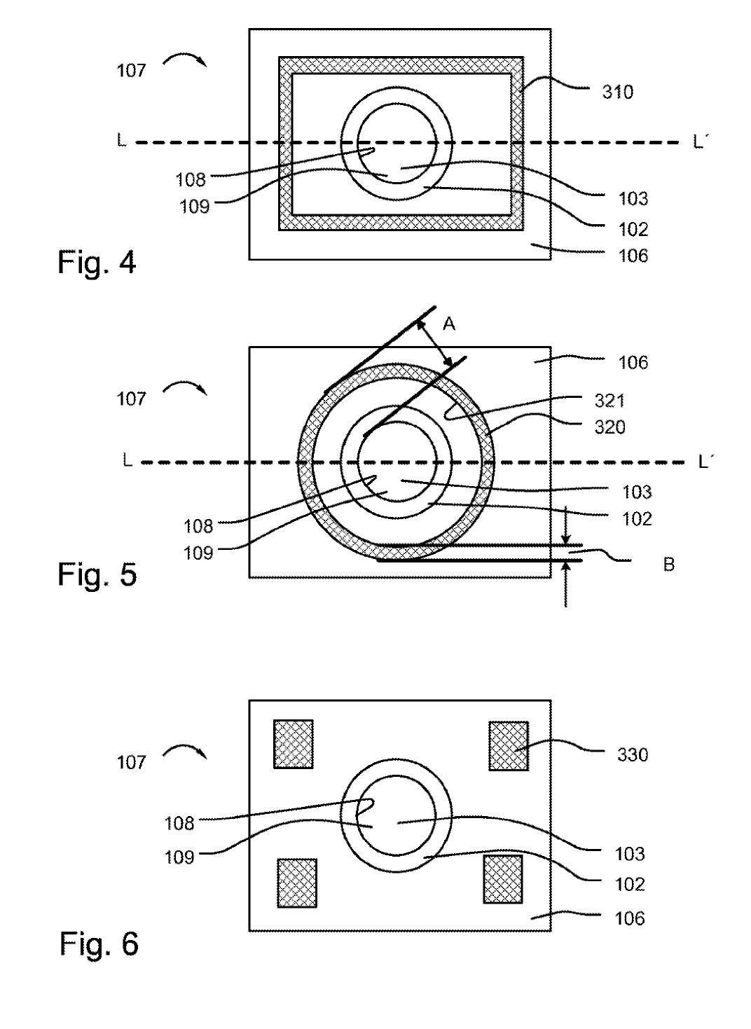

FIG. 4, FIG. 5 and FIG. 6 show various embodiments of the clamping element 300. The figures show a plan view of the lower pressing tool half 107. The inner lower pressing tool part 102 and the outer lower pressing tool part 103 are represented on the base plate 106. The cavity 109 is therefore bounded on the lower side by inner lower pressing tool part 103, and the edge 108 of the cavity 109 is formed by the outer lower pressing tool part 102. For simplified representation, the circumferential rim 104 is omitted, although the comments below are not restricted to an inner lower pressing tool part 103 without a circumferential rim 104, but may be applied to any type of pressing tool part.

The clamping element 300 is applied on the base plate 106 and firmly connected, for example screwed, adhesively bonded, welded, pressed in or pinned, to the base plate 106. The clamping element 300 is preferably made of hardened steel.

FIG. 4 shows a clamping element 310 in the form of a frame, which extends fully around the cavity 109. The clamping element 310 in the form of a frame is formed, in particular, in one piece. FIG. 4 shows the example of a circular cavity 109, although the cavity 109 may also be square or rectangular. In the case of a square or rectangular cavity 109, the clamping element 310 in the form of a frame may have a constant distance from the edge 108 of the cavity 109.

FIG. 5 shows a clamping element 320 in the form of a circular ring, which likewise extends fully around the cavity. The clamping element 320 in the form of a circular ring is preferably formed in one piece.

FIG. 5 shows the example of a circular cavity 109, and the clamping element 320 in the form of a circular ring preferably has a constant distance A from the edge of the cavity 109, that is to say the distance between the side 321 of the clamping element 320 in the form of a circular ring facing toward the cavity 109 and the edge 108 of the cavity 109 is constant. The distance may however also be variable, particularly in the case of a clamping element 320 in the form of a circular ring and a square or rectangular cavity 109. The clamping element 320 in the form of a circular ring preferably has a constant width B, that is to say the extent of the clamping element 320 along the lateral direction is constant.

Both the clamping element 310 of FIG. 4 in the form of a frame and the clamping element 320 of FIG. 5 in the form of a circular ring can vary in their height H inside the clamping element 310, 320, as shown in FIG. 1. That is to say, the distance between the upper side of the base plate 106 and the upper side of the clamping element 310, 320 may be different along the clamping element 310, 320.

This varying height may either be provided already during production of the clamping element 310, 320 or achieved subsequently by additional compensating elements, for example underlay plates of hardened steel. In this way, tilts or tool tolerances can be compensated for in a controlled way. If, for example, a special tool configuration is already known before production of the clamping element 310, 320, then the clamping element 310, 320 may be produced in a controlled way in respect of its shape and height so that the tool tolerances are compensated for optimally, that is to say the alignment of the pressing tool halves 101, 107 with respect to one another is carried out in such a way that the silicone element 410 has no thickness variations, or only insubstantial thickness variations.

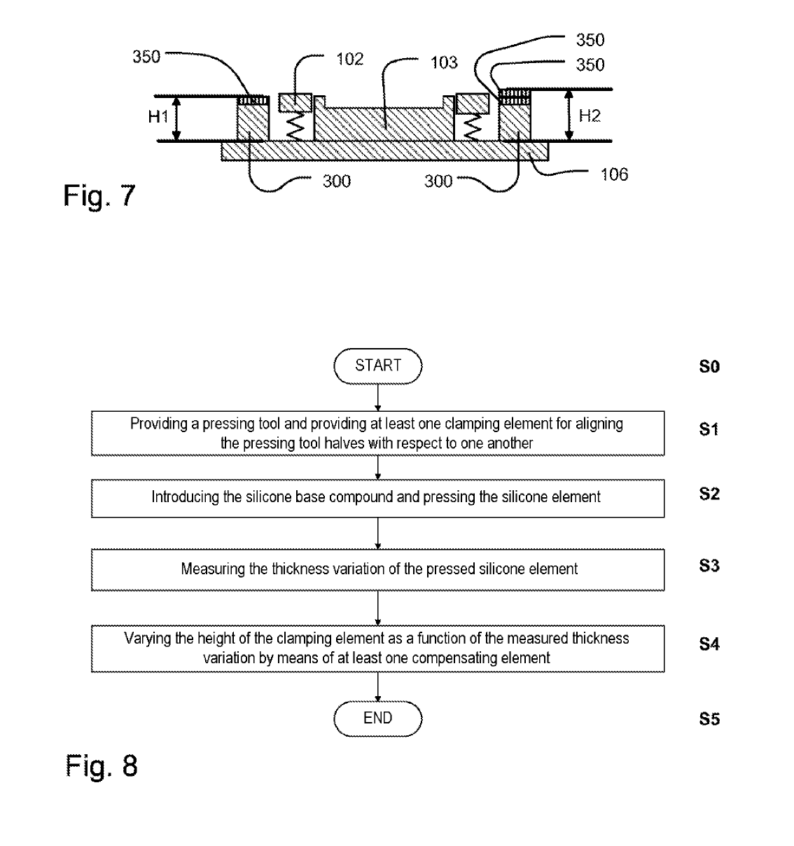

As an alternative, once or several times iteratively, the thickness variation within the thickness of the silicone element 410 may be measured after the pressing of a silicone element 410, and then the height of the clamping element 310, 320 may subsequently be modified in a controlled way at one or more positions by compensating elements, for example by one or more underlay plates, so that the alignment of the pressing tool halves with respect to one another is adapted in such a way that the silicone element 410 has an essentially constant thickness. This is illustrated by way of example in FIG. 7. FIG. 7 shows a sectional view along the line L-L′ in FIG. 4, or FIG. 5. The representation is in this case not true to scale but only schematic. The principle can therefore be applied both to a clamping element 310 in the form of a frame, as represented in FIG. 4, and to a clamping element 320 in the form of a circular ring, as represented in FIG. 5. In order to obtain different heights within the clamping element 300, compensating elements 350, for example in the form of underlay plates or underlay disks, may be applied at one or more positions of the clamping element 300. As shown in FIG. 7, a compensating element 350 is applied at a first position of the clamping element 300 so as to achieve an overall height H1 at this first position of the clamping element 300. In order to obtain a second height H2 of the clamping element 300 at a second position, more than one compensating element 350 may be applied there, for example two compensating elements 350 as shown in FIG. 7.

As an alternative, a single but higher compensating element may also be applied. The compensating elements 350 may have any desired shape and extent, although the compensating elements 350 preferably do not extend laterally beyond the clamping element 300. The compensating elements 350 preferably have a height of from 10 μm to 10 cm.

FIG. 6 shows another embodiment of a clamping element 300, in which the clamping element 300 consists of a plurality of clamping blocks 330. In this case, a plan view of the lower pressing tool half 107 is again shown. In this embodiment, the clamping element is formed by four clamping blocks 330, which are respectively arranged at the corners of the rectangular base plate 106 at an equal distance from the cavity 109. It is, however, also possible to use only two, or three or even more than four clamping blocks. The clamping blocks 330 may in plan view have the same shape as shown in FIG. 6, or they may have different shapes and extents. In particular, the clamping blocks 330 may differ from one another in their respective height. The adaptation of the height of the clamping blocks 330 to the respective tool configuration is carried out as described in relation to the embodiments according to FIG. 4 and FIG. 5, that is to say the clamping blocks 330 may have different heights from the start, and/or the height may be varied by applying one or more compensating elements 350.

Referring to FIG. 8, a method according to the disclosure for producing a silicone element 410 will now be explained in more detail.

The method begins in step S0. In the first step S1, a pressing tool 100 is provided and at least one clamping element 300 is provided for aligning the pressing tool halves 101, 107 with respect to one another. This includes the application of both a clamping element 300 and possible additional aligning elements 350.

In the following step S2, the silicone base compound 400 is introduced into the cavity 109 and the silicone element 410 is pressed.

In the ideal case, the pressing tool halves are already aligned with respect to one another by the clamping element 300, and optionally by the compensating elements 350, in such a way that the silicone element 410 has an essentially constant thickness. This may be checked in a subsequent measurement step S3. If the silicone element 410 has undesired thickness variations, in the following step S4 the height of the clamping element 300 may be modified accordingly at one or more positions by applying one or more compensating elements 350. Steps S3 and S4 may be repeated iteratively after each pressing process, until the desired accuracy with respect to the thickness of the silicone element 410 is achieved. The process ends in step S5.

With the present disclosure, tolerances in the pressing tool can therefore be compensated for in a straightforward way so that the pressed silicone element 410 has thickness variations in the range of at most 10 μm, in particular less than 7 μm.

Without the pressing tool according to the disclosure, the variations are in the range of from 10 μm to 20 μm.

### CONCLUDING REMARK

The optoelectronic semiconductor component and the method for producing an optoelectronic semiconductor component have been described with the aid of a few embodiments in order to illustrate the underlying concept. The embodiments are not restricted to particular feature combinations. Even though some features and configurations have been described only in connection with a particular embodiment or individual embodiments, they may respectively be combined with other features from other embodiments. It is likewise possible to omit or add individual features or particular configurations presented in embodiments, so long as the general technical teaching is still implemented.

Even though the steps of the method for producing an optoelectronic semiconductor component are described in a particular sequence, it is clear that each of the methods described in this disclosure may be carried out in any other appropriate sequence, and method steps may also be omitted or added so long as this does not depart from the basic concept of the technical teaching described.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

### LIST OF REFERENCES

100 pressing tool
101 upper pressing tool half
102 outer lower pressing tool part
103 inner lower pressing tool part
104 circumferential rim
105 springing
106 base plate
107 lower pressing tool half
108 edge of the cavity 109
109 cavity
110 clamping ring
111 groove
200 carrier foil
300 clamping element
310 clamping element in the form of a frame
320 clamping element in the form of a circular ring
330 clamping block
350 compensating element
400 silicone base compound
410 silicone element

1. A pressing tool for pressing a silicone element comprising:
an upper pressing tool half and a lower pressing tool half, which in the closed state of the pressing tool form a cavity for pressing a silicone element, and
a carrier foil, which bears on one of the pressing tool halves, for the silicone element to be pressed,
wherein at least the upper pressing tool half or the lower pressing tool half has at least one clamping element for aligning the two pressing tool halves with respect to one another, and wherein the clamping element is arranged between the pressing tool halves and outside the region covered by the carrier foil.

2. The pressing tool as claimed in claim 1,
wherein the clamping element in the closed state of the pressing tool is in at least indirect contact with the two pressing tool halves and is provided for clamping force transmission between the pressing tool halves.

3. The pressing tool as claimed in claim 1,
wherein the clamping element is rigidly connected to the pressing tool half which has the clamping element.

4. The pressing tool as claimed in claim 1,
wherein the clamping element extends around the cavity.

5. The pressing tool as claimed in claim 4,
wherein the clamping element has a constant circumferential distance from an edge of the cavity.

6. The pressing tool as claimed in claim 1,
wherein the clamping element is in the form of a frame or in the form of a circular ring.

7. The pressing tool as claimed in claim 6,
wherein the clamping element has a constant width.

8. The pressing tool as claimed in claim 1,
wherein the clamping element consists of a plurality of clamping blocks.

9. The pressing tool as claimed in claim 1,
wherein the clamping element varies in its height.

10. The pressing tool as claimed in claim 9,
wherein the clamping element has at least one compensating element applied for the height variation.

11. The pressing tool as claimed in claim 1,
wherein the clamping element is made of steel.

12. The pressing tool as claimed in claim 1,
wherein the carrier foil is made of polytetrafluoroethylene.

13. A method for producing a silicone element by means of a pressing tool,
the pressing tool comprising:
an upper pressing tool half and a lower pressing tool half, which in the closed state of the pressing tool form a cavity for pressing a silicone element, and
a carrier foil, which bears on one of the pressing tool halves, for the silicone element to be pressed,
wherein at least the upper pressing tool half or the lower pressing tool half has at least one clamping element for aligning the two pressing tool halves with respect to one another, and wherein the clamping element is arranged between the pressing tool halves and outside the region covered by the carrier foil,
the method comprising:
providing at least one of the clamping element for aligning the pressing tool halves with respect to one another, and
pressing a silicone element by means of the pressing tool.

14. The method as claimed in claim 13, further comprising:
measuring the thickness variation of the pressed silicone element, and
varying a height of the clamping element as a function of the measured thickness variation.

15. The method as claimed in claim 13,
wherein the varying the height of the clamping element comprises placement of at least one compensating element onto the clamping element.
